(19) United States
(12) Patent Application Publication
(10) Pub. No.: US 2026/0316381 A1
(43) Pub. Date: Oct. 15, 2026

(54) SINGLE NOZZLE PELLET EXTRUDER WITH FDM FILAMENT FEED FROM THE SIDE

(71) Applicant: SIGNIFY HOLDING B.V., EINDHOVEN (NL)

(72) Inventors: RIFAT ATA MUSTAFA HIKMET, EINDHOVEN (NL); TIES VAN BOMMEL, HORST (NL)

(21) Appl. No.: 19/104,527

(22) PCT Filed: Aug. 14, 2023
(86) PCT No.: PCT/EP2023/072382

§ 371 Date: Feb. 18, 2025

(30) Foreign Application Priority Data
Aug. 18, 2022 (EP) 22190929.4

(51) Int. Cl. B29C 64/209; B29C 64/118; B29K 101/12; B33Y 10/00; B33Y 30/00; B33Y 70/10; B33Y 80/00

(52) U.S. Cl. CPC B29C 64/209; B29C 64/118; B33Y 10/00; B33Y 30/00; B33Y 70/10; B33Y 80/00; B29K 2101/12; B29K 2995/0012; B29K 2995/0088

(57) ABSTRACT

The invention provides a method for producing a 3D item (1) by means of fused deposition modelling, the method comprising a 3D printing stage using a fused deposition modeling 3D printer (500) for layer-wise depositing 3D printable material (201) to provide the 3D item (1) comprising a layer (322) of 3D printed material (202); wherein the 3D printer (500) comprises an extruder section (510), a nozzle section (520) configured downstream of the extruder section (510), a first feeder (530), and a second feeder (540); wherein the nozzle section (520) comprises a core-shell nozzle (502) comprising (i) a nozzle core (521), configured downstream of the extruder section (510), and (ii) a nozzle shell (522) (not configured downstream of the extruder section (510)); wherein the first feeder (530) is configured to feed particulate material (531) comprising a first 3D printable material (1201), to the extruder section (510), wherein the first 3D printable material (1201) comprises a first material (1211); wherein the second feeder (540) is configured to feed a filament (320) comprising second 3D printable material (2201) to the nozzle shell (522), wherein the second 3D printable material (2201) comprises a second material (2211), different from the first material (1211); wherein the 3D printing stage comprises: feeding the particulate material (531) to the extruder section (510) and feeding the filament (320) to the nozzle shell (522); generating a core-shell extrudate (321) via the core-shell nozzle (502) and; depositing the core-shell extrudate (321) to provide the 3D printed material (202) comprising a core (330) and a shell (340), at least partly enclosing the core (330), wherein the core (330) comprises the first material (1211), and wherein the shell (340) comprises the second material (2211).

### FIELD OF THE INVENTION

The invention relates to a method for manufacturing a 3D item. The invention also relates to the 3D item obtainable with such method. Further, the invention relates to a lighting device including such 3D item. Yet further, the invention may also relate to a 3D printer, such as for use in such method.

### BACKGROUND OF THE INVENTION

Additive manufacturing printers are known in the art. For instance, US2018126636 describes a 3D printer head of ejecting a multi-molding melt by receiving a molding filament and molding pellets, the 3D printer head including: a filament supply unit supplying the molding filament; a pellet supply unit supplying the molding pellets; a nozzle pipe in which a penetration portion is provided therein in a longitudinal direction, the molding pellets are supplied from the pellet supply unit, and the molding pellets move; a rotary screw which is disposed in the penetration portion of the nozzle pipe, advances the molding pellets to one end of the nozzle pipe 32 by rotation, and has a filament supply path through which the molding filament is supplied, which is formed therein in a longitudinal direction; a heating portion which melts the molding pellets and the molding filament by heating the nozzle pipe to form the multi-molding melt; and a nozzle tip which is connected to one end of the nozzle pipe and ejects the molding melt.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals, and polymers. 3D printing can also be used in producing molds which can then be used for replicating objects.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions.

3D printing can be executed using filaments or using pellets of 3D printable material. Providing filaments highly filled with fillers, however, appears to be challenging.

The use of pellets, however, may also provide 3D items which may have a relatively rough surface. This may be undesired.

Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

In a first aspect, the invention provides a method for producing a 3D printed item by means of fused deposition modelling. In embodiments, the method may comprise a 3D printing stage using a fused deposition modeling 3D printer for layer-wise depositing 3D printable material to provide the 3D item comprising a layer of 3D printed material.

Especially, the 3D printer may comprise an extruder section, a nozzle section configured downstream of the extruder section, a first feeder, and a second feeder. Further, in embodiments, the nozzle section may comprise a core-shell nozzle comprising (i) a nozzle core, configured downstream of the extruder section, and (ii) a nozzle shell (not configured downstream of the extruder section). Furthermore, in embodiments, the first feeder may be configured to feed (polymeric material comprising) particulate material, comprising a first 3D printable material, to the extruder section. Especially, the first 3D printable material may comprise a first material. Further, in embodiments, the second feeder may be configured to feed a filament comprising second 3D printable material to the nozzle shell. Especially, the second 3D printable material may comprise a second material. More especially, the second material may be different from the first material. In embodiments, the 3D printing stage may comprise feeding the particulate material to the extruder section and feeding the filament to the nozzle shell. In further embodiments, the 3D printing stage may comprise generating a core-shell extrudate via the core-shell nozzle and depositing the core-shell extrudate to provide the 3D printed material comprising a core and a shell, at least partly enclosing the core. Especially, the core may comprise the first material, and the shell may comprise the second material. Hence, in specific embodiments the invention provides a method for producing a 3D item by means of fused deposition modelling, the method comprising a 3D printing stage using a fused deposition modeling 3D printer for layer-wise depositing 3D printable material to provide the 3D item comprising a layer of 3D printed material; wherein the 3D printer comprises an extruder section, a nozzle section configured downstream of the extruder section, a first feeder, and a second feeder; wherein the nozzle section comprises a core-shell nozzle comprising (i) a nozzle core, configured downstream of the extruder section, and (ii) a nozzle shell (not configured downstream of the extruder section); wherein the first feeder is configured to feed particulate material comprising a first 3D printable material, to the extruder section, wherein the first 3D printable material comprises a first material; wherein the second feeder is configured to feed a filament comprising second 3D printable material to the nozzle shell, wherein the second 3D printable material comprises a second material, different from the first material; wherein the 3D printing stage comprises: feeding the particulate material to the extruder section and feeding the filament to the nozzle shell; generating a core-shell extrudate via the core-shell nozzle and; depositing the core-shell extrudate to provide the 3D printed material comprising a core and a shell, at least partly enclosing the core, wherein the core comprises the first material, and wherein the shell comprises the second material. Hence, the method may provide a 3D item using a single nozzle pellet extruder with FDM filament feed from the side.

With such a method, 3D printed items may be made at least partly on the base of 3D printable pellets. Such pellets may be easier to make and/or to handle than filaments. Furthermore, the method may be used for printing materials which may not easily be shaped into a filament such as polymers with a high viscosity and/or (highly) filled materials, which may be relatively brittle. Yet, the present method may provide a solution for the less smooth pellet based extrudates, as the filament may provide a relatively smooth shell around at least part of the core based on pellets are starting material. Hence, by providing e.g. particulate material the core and applying a shell with less particulate material and/or a relatively low molecular polymer, a 3D item with a relative smooth surface may be provided. Especially, herein at the end of the pellet extruder space the filament may be fed sideways close to the nozzle. This may be a very versatile configuration and may increase 3D printing speed. Thus, facilitating printing (highly) filled polymers and/or polymers having a relatively high molecular weight. Further, with such a method, 3D printed material with a core-shell cross-section may be provided. Pellets of 3D printable material are an embodiment of (polymeric material comprising) particulate material.

As mentioned before, in embodiments, the invention provides a method for producing a 3D item by means of fused deposition modelling. Especially, the method may comprise a 3D printing stage using a fused deposition modeling 3D printer for layer-wise depositing 3D printable material to provide the 3D item comprising a layer of 3D printed material. Especially, fused deposition modelling may work on “additive” principle by laying down (or depositing) “3D printable material” in layers. Hence, in embodiments, the item produced by such a process may be referred to as the 3D item. As indicated above, the method comprises depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. Herein, the term “3D printable material” may also be indicated as “printable material”. In embodiments, the printer nozzle may be of the core-shell type, having two (or more) openings. The term “printer head” may also refer to a plurality of (different) printer heads; hence, the term “printer nozzle” may also refer to a plurality of (different) printer nozzles.

In embodiments, the 3D printer may comprise an extruder section. Further, in embodiments, the 3D printer may comprise a nozzle section. The nozzle section may especially have a narrower exit compared to the width of the extruder section. That is embodiments, the extruder section in specific embodiments may be cylindrical and the nozzle in specific embodiments may have a circular exit. Hence, in such an embodiments, the nozzle exit may have a smaller exit than the diameter of the extruder. Hence, in embodiments, the 3D printable material may be funneled through the nozzle such that the 3D printable material may be deposited (printed) layer-wise. Hence, in embodiments, the nozzle section may be configured downstream of the extruder section (as the 3D printable material from the extruder section escapes (from the printer head) via the nozzle section), especially a nozzle core (see also below). Hence, an extrudate of the nozzle may be a filament like material, whereas the starting material may thus be (polymeric material comprising) particulate material (such as pellets).

The terms “upstream” and “downstream” relate to an arrangement of items or features relative to the direction of propagation of 3D printable material (here especially within the 3D printer), wherein downstream may be defined as the direction along the flow of the 3D printable material, for example, the 3D printable material may be flowed from the first feeder to the extruder section, to the nozzle, and then exit from the nozzle. Hence, this may especially be referred to as the downstream direction (or “downstream”). In a similar manner, upstream may be defined as the direction opposite to direction of flow of the 3D printable material. Hence, this may especially be referred to as the upstream direction (or “upstream”). Hence, the extruder section or the feeder may be configured upstream of the nozzle; and the nozzle may (thus) be configured downstream of the feeder or extruder.

In embodiments, the 3D printer may comprise a first feeder. Yet further, the 3D printer may comprise a second feeder. In further embodiments, the 3D printer may (also) comprise a third feeder, or (even) a fourth feeder. The first feeder, or the second feeder may provide the 3D printer with the 3D printable material.

In embodiments, the extruder section may (also) comprise a barrel. Further, in embodiments, the extruder section may also comprise a screw. Hence, the extruder section in embodiments may comprise the barrel and the screw. The barrel may provide a volume to contain the 3D printable material. Hence, in this way the 3D printable material may be fed by the first feeder. The screw, in embodiments, may perform the function of extruding or pushing the 3D printable material such that the 3D printable material may be pushed (by turning the screw) in the downstream direction towards the nozzle.

Further, in embodiments, the nozzle section may comprises a core-shell nozzle comprising a nozzle core and a nozzle shell. In embodiments, the nozzle core may be configured downstream of the extruder section. Further in embodiments, the nozzle shell may not be configured downstream of the extruder section. In other words, the particulate materials, such as pellets, is fed by the first feeder to the extruder section and escapes via the nozzle core. The filament is fed by the second feeder (directly) in the nozzle shell. Hence, the nozzle shell is not configured downstream of the extruder section. The filament may be pressed through the nozzle shell and escape from the nozzle, e.g. as shell around the core material.

In embodiments, the 3D printable material may comprise of the 3D printable core material and the 3D printable shell material. These materials may be provide as separate materials, like pellets, and may be introduced into a core-shell nozzle, in the respective core and shell part. In this way, a core-shell extrudate may be produced, leading to a deposited 3D printed material having a core-shell configuration. Alternatively, these materials may be provide core-shell filament, and may be introduced into a nozzle. In this way, a core-shell extrudate may be produced, leading to a deposited 3D printed material having a core-shell configuration. In the present invention, especially the filament 3D printable material is fed to the shell, and the particulate 3D printable material is fed to the core. Hence, in embodiments, the first feeder may be configured to feed particulate material comprising a first 3D printable material to the extruder section. Especially, the first 3D printable material may comprise a first material (see further below). Further, in embodiments, the second feeder may be configured to feed a filament comprising a second 3D printable material to the nozzle shell. Especially, the second 3D printable material may comprise a second material (see also further below).

Note that in embodiments, the first 3D printable material and the second 3D printable material may be different (see further also below). Especially, the first 3D printable material and the second 3D printable material both comprise a polymeric material, more especially a thermoplastic polymeric material.

The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials. Hence, the term “3D printable material” may also refer to a combination of two or more materials.

Hence, in embodiments, the 3D printing stage may comprise generating a core-shell extrudate via the core-shell nozzle. The term “extrudate” may be used to define the 3D printable material downstream of the printer head, but not yet deposited. The latter may be indicated as “3D printed material”. In fact, the extrudate may be considered to comprises 3D printable material, as the material is not yet deposited. Upon deposition of the 3D printable material or extrudate, the material may thus be indicated as 3D printed material.

Essentially, the materials may be the same material, as the thermoplastic material upstream of the printer head, downstream of the printer head, and when deposited, may essentially be the same material(s). Therefore, in embodiments, the 3D printing stage may comprise depositing the core-shell extrudate to provide the 3D printed material comprising a core and a shell, at least partly enclosing the core. Note that, especially, the core may comprise the first material, and the shell may comprise the second material.

In embodiments, the first material may comprise a first thermoplastic material. Further, in embodiments, the second material may comprise a second thermoplastic material. In some embodiments, the first thermoplastic material and the second thermoplastic material may be the same. However, in other embodiments, the first thermoplastic material may be different from the second thermoplastic material.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc. Optionally, the 3D printable material may comprise a 3D printable material selected from the group consisting of Urea formaldehyde, Polyester resin, Epoxy resin, Melamine formaldehyde, thermoplastic elastomer, etc. . . . Optionally, the 3D printable material may comprise a 3D printable material selected from the group consisting of a polysulfone.

Elastomers, especially thermoplastic elastomers, may especially be interesting as they are flexible and may help obtaining relatively more flexible filaments comprising the thermally conductive material. A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Suitable thermoplastic materials, such as also mentioned in WO2017/040893, may include one or more of polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyary lates, polyarylene ethers (e.g., polyphenylene ethers), polyarylene sulfides (e.g., polyphenylene sulfides), polyarylsulfones (e.g., polyphenylene sulfones), poly benzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly (C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Embodiments of polyamides may include, but are not limited to, synthetic linear poly amides, e.g., Nylon-6,6; Nylon-6,9; Nylon-6,10; Nylon-6,12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are poly(C₁₋₆ alkyl)acrylates and poly(C₁₋₆ alkyl)methacrylates, which include, for instance, polymers of methyl acrylate, ethyl acrylate, acrylamide, methacrylic acid, methyl methacrylate, n-butyl acrylate, and ethyl acrylate, etc. In embodiments, a polyolefine may include one or more of polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

In specific embodiments, the 3D printable material (and the 3D printed material) may comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action may comprises heating the 3D printable material above the glass transition and in embodiments above the melting temperature (especially when the thermoplastic polymer is a semi-crystalline polymer). In yet another embodiment, the 3D printable material comprises a (thermoplastic) polymer having a melting point (Tm), and the 3D printing stage may comprise heating the 3D printable material to be deposited at a temperature of at least the melting point. The glass transition temperature is in general not the same thing as the melting temperature. Melting is a transition which may occur in crystalline polymers. Melting may happen when the polymer chains fall out of their crystal structures, and become a disordered liquid. The glass transition may be a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

The term 3D printable material is further also elucidated below, but may especially refer to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

The printable material in embodiments may comprise particulate material, i.e. particles embedded in the printable polymeric material, which particles form a substantially discontinuous phase. The number of particles in the total mixture may especially not be larger than 60 vol. %, relative to the total volume of the printable material (including the (anisotropically conductive) particles) especially in applications for reducing thermal expansion coefficient. Hence, the 3D printable material may especially refer to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined below. Hence, in embodiments the 3D printable materials may comprises particulate additives.

In embodiments, the first material may comprise a first thermoplastic material and the second material may comprise a second thermoplastic material different from the first thermoplastic material. In specific embodiments, the first material and the second material differ in one or more of molecular weight of the thermoplastic material, viscosity, chemical composition, filler material, filler material concentration. These aspects are discussed further below.

As mentioned above, in embodiments the first thermoplastic material and the second thermoplastic material may have different molecular weights. Especially, the first thermoplastic material may have a first average molecular weight M_{n,1}. Further, in embodiments, the second thermoplastic material may have a second average molecular weight M_{n,2}. Herein, the molecular weights may especially refer to number averaged molecular weights. Especially, the method may comprise selecting the first average molecular weight M_{n,1} from the range of 10000-1000000 g/mol, such as 60000-500000 g/mol, especially 100000-250000 g/mol. More especially, the method may comprise selecting the second average molecular weight M_{n,2} from the range of 5000-1000000 g/mol, such as 10000-100000 g/mol, especially 25000-50000 g/mol. Especially, M_{n,1} and M_{n,2} may be selected such that 1<M_{n,1}/M_{n,2}≤10, especially 1<M_{n,1}/M_{n,2}≤50, more especially 1<M_{n,1}/M_{n,2}≤100. In embodiments, 2≤M_{n,1}/M_{n,2}≤100, such as 5≤M_{n,1}/M_{n,2}≤50. Hence, in a specific embodiment, the first thermoplastic material may have a first average molecular weight M_{n,1}, and wherein the second thermoplastic material may have a second average molecular weight M_{n,2}, wherein the first average molecular weight M_{n,1} is selected from the range of 60000-500000 g/mol, and wherein the second average molecular weight M_{n,2}, is selected from the range of 10000-100000 g/mol; wherein 1<M_{n,1}/M_{n,2}≤50. Such embodiments may especially be applied when the core has a relatively low (particulate) filler content.

Note that, in specific embodiments, M_{n,1} may be equal to M_{n,2} i.e. M_{n,1}=M_{n,2}.

Alternatively, in (other) embodiments, the first average molecular weight M_{n,1} may be selected from the range of 5000-1000000 g/mol, such as 10000-100000 g/mol, especially 25000-50000 g/mol. Especially, the second average molecular weight M_{n,2}, may be selected from the range of 10000-1000000 g/mol, such as 60000-500000 g/mol, especially 100000-250000 g/mol. Especially, in (other) embodiments, 1<M_{n,1}/M_{n,2}≤10, such as 1<M_{n,1}/M_{n,2}≤50, especially 1<M_{n,1}/M_{n,2}≤100. In embodiments, 2≤M_{n,1}/M_{n,2}≤100, such as 5≤M_{n,1}/M_{n,2}≤50. Such embodiments may especially be applied when the core has a relatively high (particulate) filler content.

In embodiments, the first thermoplastic material may have a first transition temperature T_{t,1} selected from a first glass transition temperature T_{g,1} and a first melting temperature T_{m,1}. Further, in embodiments, the second thermoplastic material may have a second transition temperature T_{t,2} selected from a second glass transition temperature T_{g,2} and a second melting temperature T_{m,2}. The first thermoplastic polymer and the second thermoplastic polymer may differ in glass transition temperature. Alternatively or additionally, the first thermoplastic polymer and the second thermoplastic polymer may differ in melting temperature.

In embodiments, the method comprises controlling a nozzle temperature Tₙ. Especially, during at least part of the 3D printing stage Tₙ>T_{t,1} and Tₙ>T_{t,2} applies. As mentioned above, at temperatures higher than the transition temperature, in embodiments, the first thermoplastic material and the second thermoplastic material may especially be less viscous and hence may be flowed via the nozzle. Hence, in this way, with a nozzle temperature higher than the transition temperature of both the first transition temperature and the second transition temperature, the first thermoplastic material and the second thermoplastic material may both be provided at a temperature wherein they may be flowed (via the nozzle). Especially, Tₙ≥(T_{m,1}+10° C.) and Tₙ≥(T_{m,2}+10 °C). More especially Tₙ≥(T_{m,1}+100° C.) and Tₙ≥(T_{m,2}+100° C.)). Hence, in this way, by providing a nozzle temperature (significantly) larger than the transition temperature of the first thermoplastic polymer and the second thermoplastic polymer, the flowability of the first thermoplastic polymer and the second thermoplastic polymer may be increased. Hence, in a specific embodiments, the first thermoplastic material may have a first transition temperature T_{t,1} selected from a first glass transition temperature T_{g,1} and a first melting temperature T_{m,1}, wherein the second thermoplastic material may have a second transition temperature T_{t,2} selected from a second glass transition temperature T_{g,2} and a second melting temperature T_{m,2}, wherein the method may comprise controlling a nozzle temperature Tₙ, wherein during at least part of the 3D printing stage Tₙ>T_{t,1} and Tₙ>T_{t,2} applies (especially wherein Tₙ≥(T_{m,1}+10° C.) and Tₙ≥(T_{m,2}+10° C., more especially wherein Tₙ≥(T_{m,1}+100° C.) and Tₙ≥(T_{m,2}+100° C.)).

Note that, in embodiments, the viscosity of the first thermoplastic material and the second thermoplastic material may not be the same. However, in other embodiments, the viscosity of the first thermoplastic material and the second thermoplastic material may be the same.

In embodiments, the first 3D printable material (comprising the first thermoplastic material) may have a first viscosity PV1, and the second 3D printable material (comprising the second thermoplastic material) may have a second viscosity PV2. Especially, the first thermoplastic material and the second 3D printable material may be selected such that 1<PV1/PV2≤50, such as 1<PV1/PV2≤500, especially 1<PV1/PV2≤5000. More especially, 10<PV1/PV2≤5000, such as 100<PV1/PV2≤5000, especially 1000<PV1/PV2≤5000. Hence, in specific embodiments, the first 3D printable material may have a first viscosity PV1, and the second 3D printable material may have a second viscosity PV2, different from the first viscosity PV1, wherein 1<PV1/PV2≤500. Alternatively, in embodiments, the first 3D printable material may have a first viscosity PV1, and wherein the second 3D printable material may have a second viscosity PV2, different from the first viscosity PV1, wherein 1<PV2/PV1≤50, such as 1<PV2/PV1≤500, especially 1<PV2/PV1≤5000. More especially, 10<PV2/PV1≤5000, such as 100<PV2/PV1≤5000, especially 1000<PV2/PV1≤5000. Especially, PV1 may be larger than PV2 or vice versa.

Likewise, this may apply to the (respective) 3D printed materials. Note that, in embodiments, the 3D printable material may comprise particulate filler material. Especially, the core may comprise particulate filler material. Hence, in such an embodiment, viscosity may especially refer to the viscosity of the 3D printable material, be it the first 3D printable material or the second 3D printable material. It is apparent to the skilled person that viscosities may be determined, for instance using a rheometer. The viscosity may e.g. be determined at a temperature where the 3D printable materials are (both) flowable through the nozzle, such as at a temperature also suitable as nozzle temperature.

The first 3D printable material may comprise a first material and the second 3D printable material may comprise a second material, wherein these materials may differ.

Assuming that both the 3D printable materials comprise thermoplastic materials, the 3D printable materials may differ in the type of thermoplastic materials and/or molecular weight of the thermoplastic materials. Hence, the thermoplastic materials may essentially be the same type of polymeric materials, like both PE, but only differ in molecular weight. Of course, the thermoplastic materials may also differ in type, like PE and PC. Assuming that one of the first 3D printable material and the second 3D printable material comprises a filler material, and the other one does not, the 3D printable materials may differ in the presence of the filler material. Assuming that both the first 3D printable material and the second 3D printable material comprises a filler material, the 3D printable materials may differ in the concentration of the filler material and/or in the type of materials.

Hence, the first material and the second may in embodiment differ in the type of thermoplastic material, in the type of (particulate) filler material, in the weight percentage of the (particulate) filler material(s), in the composition of the thermoplastic materials, etc.

In embodiments, the first material may comprise a first thermoplastic material and optionally comprise a first filler material. Especially, the first material may have a first melt volume rate (MVR1). In embodiments, the second material may comprise a second thermoplastic material and optionally comprise a second filler material. Especially, the second material may have a second melt volume rate (MVR2).

Filler materials may especially be advantageous in altering certain characteristics of the first thermoplastic material and/or the second thermoplastic material. For instance, the concentration of the first thermoplastic material in the first material may especially be controlled i.e. its volume percentage may be varied by using the first filler material. Similarly, in embodiments, the same may apply to the second material comprising a second filler material and second thermoplastic material. Especially, the viscosity of the first material or the second material may be varied by using the first filler material or the second filler material respectively. In embodiments, other characteristics of the first material and/or the second material may be controlled, such as surface properties, roughness, light transmissive properties, weight, etc.

The melt volume rate (or “melt volume-flow rate”) is the rate of extrusion of a molten resin through a die of specified length and diameter under prescribed conditions of temperature, load and piston position in the barrel of an extrusion plastometer, the rate being determined as the volume extruded over a specified time. In embodiments, the first melt volume rate (MVR1) may be selected from the range of 0.01-100 cm³/(10 min.), such as 0.1-10 cm³/(10 min.), especially 0.5-7.5 cm³/(10 min.). In embodiments, the second melt volume rate (MVR2) may be selected from the range of 0.1-300 cm³/(10 min.), such as 1-30 cm³/(10 min.), especially 10-20 cm³/(10 min.). In embodiments, MVR1 and MVR2 may be selected such that 1<MVR1/MVR2≤0.0003, such as 1<MVR1/MVR2≤0.003, especially 1<MVR1/MVR2≤0.03. (according to ISO 1133 12 at 300° C. and 1.2 kg). The SI unit of melt volume rate is decimeters per minute (dm³/min). The ISO standard defines the melt volume rate in cubic centimeters per 10 minutes (cm³/10 min). ISO 1133 12, which defines the dimensions, temperature, and weight, may e.g. be used to measure amount of material coming out per unit time (cm³/10 min). The temperature and the weight used during the measurement may for e.g. be 300° C. and 1.2 kg, respectively. Hence, in a specific embodiment, the first material may optionally comprise a first filler material, wherein the first material may have a first melt volume rate (MVR1); wherein the second material may optionally comprise a second filler material, wherein the second material (1211) has a second melt volume rate (MVR2), wherein the first melt volume rate (MVR1) is selected from the range of 0.1-1 cm³/(10 min.), wherein the second melt volume rate (MVR2) is selected from the range of 1-30 cm³/(10 min.); wherein 1<MVR1/MVR2≤0.003 (according to ISO 1133 12 at 300° C. and 1.2 kg). In other embodiments, however, 1<MVR2/MVR1≤0.0003, such as 1<MVR2/MVR1≤0.003, especially 1<MVR2/MVR1≤0.03. Especially, however, the more viscous 3D printable material may be fed to the nozzle via the extruder section.

As mentioned before, the volume percentage (i.e. the fraction of the volume of the first material (or second material) comprised by the first thermoplastic material (or second thermoplastic material)) may be controlled. In embodiments the first material may comprise a (particulate) first filler material at a first volume percentage V1 relative to the first material. The (particulate) first filler material may be embedded in the first thermoplastic material. Further, in embodiments, the second material may optionally comprise a (particulate) second filler material at a second volume percentage V2 relative to the second material. The (particulate) second filler material may be embedded in the second thermoplastic material. Hence, in embodiments V1 may be 0 vol %. In other embodiments, V2 may be 0 vol. %. Yet, in other embodiments V1>V2, wherein V2 may be 0 vol. %, or larger. However, in yet other embodiments V2>V1, wherein V1 may be 0 vol. %, or larger.

Especially, in embodiments the first volume percentage V1 may be selected from the range of 0-90 vol. %, such as 5-50 vol. %, especially 10-25 vol. %. Note that in embodiments where first filler material may not be used, the volume percentage of the first filler material may be 0 vol. % i.e. the core may be filled completely with first thermoplastic material. Analogously, in embodiments, the second volume percentage V2 may be selected from the range of 0-30 vol. %, such as 0-15 vol. %, especially 0-10 vol. %. More especially, the second volume percentage V2 may be selected from the range of 5-30 vol. %, such as 10-30 vol. %, especially 15-30 vol. %. Note (also) that in embodiments where second filler material may not be used, the volume percentage of the second filler material may be 0 vol. % i.e. the shell may be filled completely with second thermoplastic material. In embodiments, V1 and V2 may be selected such that 0≤V2/V1≤100, especially 0≤V2/V1≤10, more especially 0≤V2/V1≤1. More especially, in embodiments, V1 and V2 may be selected such that 0≤V2/V1<1, especially 0≤V2/V1≤0.5, such as 0≤V2/V1≤0.05, like 0≤V2/V1≤0.01. Hence, in embodiments, in this way, the core may especially comprise more filler material than the shell. For instance, the core may comprise more particulate filler material than the shell. In a specific embodiments, the first material may comprise a first filler material at a first volume percentage V1 relative to the first material, and wherein the second material may optionally comprises a second filler material at a second volume percentage V2 relative to the second material, wherein the first volume percentage V1 is selected from the range of 5-50 vol. %, wherein the second volume percentage V2 is selected from the range of 0-15 vol. %, and wherein 0≤V2/V1≤0.5. However, in other embodiments, the core may also be devoid of particulate material.

Further, in embodiments, the first material may comprise a first filler material at a first volume percentage V1 relative to the first material. Analogously, in embodiments, the second material may comprise a second filler material at a second volume percentage V2 relative to the second material. In embodiments, the first filler material and the second filler material (as indicated previously) may be optional. Further, in embodiments, the first filler material and the second filler material may especially be different filler materials. Hence, in a specific embodiment, the first material may comprise a first filler material at a first volume percentage V1 relative to the first material, and wherein the second material may comprise a second filler material at a second volume percentage V2 relative to the second material, wherein the first filler material and the second filler material may be different filler materials. However, in embodiments, they may (also) be the same material. In specific embodiments, when the filler materials are the same material, the volume percentages may differ. As indicated above, the filler materials may also differ, and the respective volume percentages may differ (or optionally be the same).

Especially, in embodiments the first filler material is a particulate material. Alternatively or additionally, in embodiments the second filler material is a particulate material.

In embodiments, a control system may be configured to control 3D printing conditions. In embodiments, the control system may control a fused deposition modelling 3D printer (see also below). In embodiments, a first volumetric flow rate of the particulate material (to the extruder section) may be controlled. Further, in embodiments, a second volumetric flow rate of the filament (to the nozzle shell) may be controlled. Yet further, in embodiments, a nozzle temperature Tₙ (as previously defined) may be controlled. The viscosity of the first material and the second material may especially be dependent on temperature. Therefore, at a higher temperature and hence, at a lower viscosity, the flow rate of the first material and/or the second material may be controlled and hence, the first volumetric flow rate and the second volumetric flow rate may be controlled. Hence, in specific embodiments a control system may be configured to control 3D printing conditions; wherein the 3D printing conditions may be selected from the group of: a first volumetric flow rate of the particulate material (to the extruder section), (ii) a second volumetric flow rate of the filament (to the nozzle shell), and (iii) a nozzle temperature Tₙ as previously defined.

In embodiments, the method may further comprise monitoring a parameter related to particle dimensions (dl) of the particulate material (i.e. first 3D printable material). Especially, the particle dimension (dl) may relate to the dimensions of the particulate material such as the length, or the width, or the height, or the diameter. More especially, other parameters, such as the weight, density, the polydispersity in particulate material characteristics (such as a distribution in particle size, shape, density, etc) may be controlled. Further, in embodiments, the method may comprise controlling 3D printing conditions in dependence of the parameter related to the particle dimensions (d1) (of the particles or pallets of 3D printable material). Especially, the energy input to the extruder section may be controlled. Further, in embodiments, the parameter related to particle dimensions (d1) may be selected from the group of: (a) particle dimensions (d1), and (b) energy input to the extruder section. Hence, in a specific embodiment, the method may further comprise: monitoring a parameter related to particle dimensions (d1) of the particulate material and controlling 3D printing conditions in dependence of the parameter related to the particle dimensions (d1); and wherein the parameter related to particle dimensions (d1) is selected from the group of: (a) particle dimensions (d1), and (b) energy input to the extruder section. Hence, in this way, in embodiments, the material output (weigh per unit time constant) from the printer nozzle may e.g. be constant.

Especially, the 3D printed item may comprise one or more layers of 3D printed material. More especially, the 3D printed item comprises a plurality of layers of 3D printed material. The 3D printed item may comprise two or more, like at least 5, such as at least 10, like in embodiments at least 20 layers of 3D printed material. Hence, especially, the layer part may be provided according the herein described method for producing a 3D printed item.

The 3D printed item may comprise a plurality of layers on top of each other, i.e. stacked layers. The width (thickness) and height of (individually 3D printed) layers may e.g. in embodiments be selected from the range of 100-5000 μm, such as 200-2500 μm, with the height in general being smaller than the width. For instance, the ratio of height and width may be equal to or smaller than 0.8, such as equal to or smaller than 0.6.

Layers may be core-shell layers or may consist of a single material. Within a layer, there may also be a change in composition, for instance when a core-shell printing process was applied and during the printing process it was changed from printing a first material (and not printing a second material) to printing a second material (and not printing the first material).

The herein described method provides 3D printed items. Hence, the invention also provides in a further aspect a 3D printed item obtainable with the herein described method. At least part of the 3D printed item may include a coating.

Some specific embodiments in relation to the 3D printed item have already been elucidated above when discussing the method. Below, some specific embodiments in relation to the 3D printed item are discussed in more detail.

In a further aspect a 3D printed item obtainable with the herein described method is provided. Especially, the invention provides a 3D item that may comprise 3D printed material. Especially, the 3D item may comprise a layer of 3D printed material. The 3D printing stage as described above may provide the 3D item by layer-wise deposition of 3D printable material.

Layer by layer printable material may be deposited, by which the 3D printed item may be generated (during the printing stage). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, etc. Post-processing may include smoothening the ribbed structures, which may lead to an essentially smooth surface.

In embodiments, the layer may comprise a core-shell cross-section, comprising a core and a shell. Especially, the shell may be at least partly enclosing the core. In embodiments, in this way (as described in the 3D printing stage), a highly filled material may be provided in the core, for example, the core may be filled with (particulate) filler material (embedded in the thermoplastic material).

Further, in embodiments, the core may comprise a first material. Especially, the shell may comprise a second material. In embodiments, as mentioned before, the core and the shell may especially comprise the same material i.e. the first material may be the same as the second material. However, in other embodiments, the core and the shell may comprise different materials i.e. the first material may be different from the second material. Note that, in embodiments, the core may have a first perimeter (pl) with first deviations (R1) therefrom defining a first root mean square roughness RMS1. Further, in embodiments, the shell may have a second perimeter (p2) with second deviations (R2) therefrom defining a second root mean square roughness RMS 2. Especially, it may be desirable to provide a 3D item with a specific surface roughness. Hence, in embodiments, the shell comprising the second material may especially be selected such that it has a relatively lower surface roughness compared to core comprising the first material. Hence, in embodiments, RMS1 and RMS2 may be selected such that RMS1/RMS2≤5, such as RMS1/RMS2≤0.5, especially RMS1/RMS2≤0.05. Hence, in specific embodiments, the invention may provide a 3D item comprising 3D printed material, wherein the 3D item comprises a layer of 3D printed material, wherein the layer comprises a core-shell cross-section, comprising a core and a shell, at least partly enclosing the core, wherein the core comprises a first material, and wherein the shell comprises a second material, different from the first material, wherein the core has a first perimeter (p1) with first deviations (R1) therefrom defining a first root mean square roughness RMS1, wherein the shell has a second perimeter (p2) with second deviations (R2) therefrom defining a second root mean square roughness RMS2, wherein RMS1/RMS2≤0.5. In embodiments, the first root mean square roughness RMS1 may be selected from the range of about 5-25 μm.

In embodiments, the first material may comprise a first thermoplastic material. Further, in embodiments, the second material may comprise a second thermoplastic material, different from the first thermoplastic material.

In other embodiments, the first thermoplastic material and the second thermoplastic material may especially be the same. This may provide the benefit of increasing adhesiveness between the core and the shell. Likewise, this may apply when the first thermoplastic material and the second are essentially chemically the same, but only differ in molecular weight, light e.g. HDPE and LDPE.

As mentioned before, the first material and the second material may differ in one or more of molecular weight of the thermoplastic material, viscosity, chemical composition (especially of the thermoplastic material), filler material, filler material concentration.

As mentioned previously, in embodiments the first thermoplastic material and the second thermoplastic material may have a different molecular weight. Especially, the first thermoplastic material may have a first average molecular weight M_{n,1}. Further, in embodiments, the second thermoplastic material may have a second average molecular weight M_{n,2}. Especially, the first average molecular weight M_{n,1} may be selected from the range of 10000-1000000 g/mol, such as 60000-500000 g/mol, especially 100000-250000 g/mol. More especially, the second average molecular weight M_{n,2} may be selected from the range of 5000-1000000 g/mol, such as 10000-100000 g/mol, especially 25000-50000 g/mol. Especially, M_{n,1} and M_{n,2} may be selected such that 1<M_{n,1}/M_{n,2}≤10, especially 1<M_{n,1}/M_{n,2}≤50, more especially 1<M_{n,1}/M_{n,2}≤100. Note that, in specific embodiments, M_{n,1} may be equal to M_{n,2}i.e. M_{n,1}=M_{n,2}. Hence, in specific embodiments, the first thermoplastic material may have a first average molecular weight M_{n,1}, and wherein the second thermoplastic material may have a second average molecular weight M_{n,2}, wherein the first average molecular weight M_{n,1} is selected from the range of 60000-500000 g/mol, and wherein the second average molecular weight M_{n,2}, is selected from the range of 10000-100000 g/mol; wherein 1<M_{n,1}/M_{n,2}≤50.

Alternatively, in embodiments, the first average molecular weight M_{n,1} may be selected from the range of 5000-1000000 g/mol, such as 10000-100000 g/mol, especially 25000-50000 g/mol. Especially, the second average molecular weight M_{n,2}, may be selected from the range of 10000-1000000 g/mol, such as 60000-500000 g/mol, especially 100000-250000 g/mol. Especially, 1≤M_{n,1}/M_{n,2}≤50, more especially 1<M_{n,1}/M_{n,2}≤50.

In embodiments, the first material may have a first viscosity PV1. More especially, the second material may have a second viscosity PV2. In embodiments, PV1 may be the same as PV2. However, in other embodiments, PV1 and PV2 may be different. As mentioned before, especially, the first thermoplastic material and the second thermoplastic material may be selected such that 1<PV1/PV2≤50, such as 1<PV1/PV2≤500, especially 1<PV1/PV2≤5000. More especially, 10<PV1/PV2≤5000, such as 100<PV1/PV2≤5000, especially 1000<PV1/PV2≤5000. Alternatively, in embodiments, the first material may have a first viscosity PV1, and wherein the second material may have a second viscosity PV2,different from the first viscosity PV1, wherein 1<PV2/PV1≤50, such as 1<PV2/PV1≤500, especially 1<PV2/PV1≤5000. More especially, 10<PV2/PV1≤5000, such as 100<PV2/PV1≤5000, especially 1000<PV2/PV1≤5000. Especially, PV1 may be larger than PV2 or vice versa.

In embodiments, the first material may have a first melt volume rate (MVR1). Further, in embodiments, the second material may optionally comprise a second filler material. Especially, the second material may have a second melt volume rate (MVR2). As mentioned before, the first filler material and/or the second filler material may be optional, and hence, in embodiments first material and/or second material may (also) not comprise first filler material and/or the second filler material, respectively.

Further, as mentioned before, in embodiments, the second melt volume rate (MVR2) may be selected from the range of 0.1-300 cm³/(10 min.), such as 1-30 cm³/(10 min.), especially 10-20 cm³/(10 min.). In embodiments, MVR1 and MVR2 may be selected such that 1<MVR1/MVR2≤0.0003, such as 1<MVR1/MVR2≤0.003, 1<MVR1/MVR2≤0.03 (according to ISO 1133 12 at 300° C. and 1.2 kg). ISO 1133 12, which defines the dimensions, temperature, and weight, may e.g. be used to measure amount of material coming out per unit time (cm3/10 min). The temperature and the weight used during the measurement may e.g. be 300° C. and 1.2 kg (plunger weight), respectively, according to ISO 1133 12 has been defined, see above.

Further in embodiments, the first material may further comprise a first filler material at a first volume percentage V1 relative to the first material. Further, in embodiments, the second material may further comprise a second filler material at a second volume percentage V2 relative to the second material. More especially, the first filler material and the second filler material may be different filler materials. However, in embodiments, the first filler material and the second filler material may be the same material. In embodiments, V1 may be in the range of 0-90 vol. %, such as 5-50 vol. %, especially 10-25 vol. %. As mentioned before, some embodiments which may not comprise the first filler material, the volume percentage of the first filler material may be 0 vol. % i.e. the core may be filled completely with first thermoplastic material. Analogously, in embodiments, V2 may be in the range of 0-30 vol. %, such as 0-15 vol. %, especially 0-10 vol. %. More especially, the second volume percentage V2 may be in the range of 5-30 vol. %, such as 10-30 vol. %, especially 15-30 vol. %. Note (also) that some embodiments may not comprise second filler material, and hence, the volume percentage of the second filler material may be 0 vol. % i.e. the shell may be filled completely with second thermoplastic material.

In embodiments, V1 and V2 may be configured such that 0≤V2/V1≤100, especially 0≤V2/V1≤10, more especially 0≤V2/V1≤1. More especially, in embodiments, V1 and V2 may be 0≤V2/V1≤5, especially 0≤V2/V1≤0.5, such as 0≤V2/V1≤0.05.

Yet further, in embodiments, the first thermoplastic material that may have a first average molecular weight M_{n,1}. Further, in embodiments, the second thermoplastic material that may have a second average molecular weight M_{n,2}. Note that, especially, in embodiments M_{n,1} may not be equal to M_{n,2} i.e. M_{n,1}≠M_{n,2}. Furthermore, in such embodiments, it may apply that M_{n,1}/M_{n,2}≤10, such as M_{n,1}/M_{n,2}≤50, especially M_{n,1}/M_{n,2}≤100. However, as indicated above, other embodiments may also be possible. Further in embodiments, at least one of the first material and the second filler material are selected from the group of glass or fibers. Hence, in embodiments, one or more of the first material and second material may contain fillers such as glass and fibers which do not have (to have) influence on the on T_{g} or Tₘ of the material(s). In embodiments, at least one of the first material and the second filler material may comprise one or more of light reflective particles, light transmissive particles, light absorbing particles, luminescent particles, magnetic particles, electrically conductive particles, etc.

As indicated above, the 3D printed item maybe used for different purposes. Amongst others, the 3D printed item maybe used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific embodiments the 3D item may be configured as one or more of (i) at least part of a lighting device housing, (ii) at least part of a wall of a lighting chamber, and (iii) an optical element. As a relative smooth surface may be provided, the 3D printed item may be used as mirror or lens, etc. . . . In embodiments, the 3D item may be configured as shade. A device or system may comprise a plurality of different 3D printed items, having different functionalities.

Returning to the 3D printing process, a specific 3D printer may be used to provide the 3D printed item described herein. Therefore, in yet a further aspect the invention also provides a fused deposition modeling 3D printer, comprising a nozzle section configured downstream of the extruder section, a first feeder, a second feeder, and a control system. In embodiments, the fused deposition modeling 3D printer may be configured to provide 3D printable material to a substrate, thereby providing a 3D item comprising 3D printed material. Further, in embodiments, the nozzle section may comprise a core-shell nozzle comprising (i) a nozzle core, configured downstream of the extruder section. Furthermore, in embodiments, the nozzle section may comprise a nozzle shell (not configured downstream of the extruder section). Further, in embodiments, the first feeder may be configured to feed particulate material comprising a first 3D printable material, to the extruder section (wherein the first 3D printable material may comprise a first material). In embodiments, the second feeder may be configured to feed a filament comprising second 3D printable material to the nozzle shell. Especially, the second 3D printable material may comprise a second material different from the first material. Yet further, in embodiments, the control system may be configured to execute the method described above. Hence, in specific embodiments, the invention may provide a fused deposition modeling 3D printer (or 3D printer), comprising an extruder section, a nozzle section configured downstream of the extruder section, a first feeder, a second feeder, and a control system; wherein the fused deposition modeling 3D printer is configured to provide 3D printable material to a substrate, thereby providing a 3D item comprising 3D printed material, wherein the nozzle section comprises a core-shell nozzle comprising (i) a nozzle core, configured downstream of the extruder section, and (ii) a nozzle shell (not configured downstream of the extruder section); wherein the first feeder is configured to feed particulate material comprising a first 3D printable material, to the extruder section, (wherein the first 3D printable material comprises a first material); wherein the second feeder is configured to feed a filament comprising second 3D printable material to the nozzle shell, (wherein the second 3D printable material comprises a second material, different from the first material); and wherein the control system is configured to execute the method (described above).

Especially, the fused deposition modeling 3D printer may be configured to provide 3D printable material to a substrate, thereby providing a 3D item comprising 3D printed material. Hence, in this way, embodiments of the 3D printer may be used to provide the 3D item using the 3D printing method. Especially, 3D items may be provided by layer-wise deposition wherein each layer may comprise a core-shell configuration. More especially, the 3D item may comprise 3D printed material wherein the 3D printed material may comprise one or more different types of 3D printed material. However, they may also be the same in specific embodiments.

As mentioned above, the fused deposition modeling 3D printer may comprise a nozzle section configured downstream of the extruder section, a first feeder, a second feeder, and a control system. In embodiments, the extruder section may provide a volume to contain at least part of the 3D printable material. Especially, the 3D printer may comprise a screw and barrel, wherein the screw and barrel may provide the advantage of controlling the extrudate i.e. the amount (or volume percentage) of 3D printable material deposited on a receiver item or substrate to provide the 3D item. Especially, the 3D printable material may extrude the 3D printable material in a downstream direction such that the 3D printable material is deposited via the nozzle. Note that, in embodiments, a part of the 3D printable material may (also) be provided directly to the nozzle i.e. the 3D printable material may not be provided to the extruder volume.

In embodiments, the nozzle section may comprise a core-shell nozzle further comprising (i) a nozzle core configured downstream of the extruder section. Further, in embodiments, the 3D printer may comprise a nozzle shell (not configured downstream of the extruder section). Hence, in this way, the one or more 3D printable materials may be used to provide the 3D item. Especially, the one or more 3D printable material may be mixed within the 3D printer. More especially, the 3D printer may provide extrudate from the nozzle with a core-shell configuration, such that the shell covers the core.

Further, in embodiments, the first feeder may be configured to feed particulate material comprising a first 3D printable material to the extruder section. Especially, the first 3D printable material may comprise a first 3D printable material. In embodiments, the 3D printer may comprise the second feeder, which may be configured to feed a filament comprising second 3D printable material to the nozzle shell. Especially, the second 3D printable material may comprise a second material, different from the first material. Hence, 3D printable material comprising one or more different 3D printable material may be used to provide the 3D item, wherein the 3D item may be provided by layer-wise deposition with layers comprising a core shell configuration.

The first feeder and/or the second feeder may provide 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material to a substrate, as defined above and/or the 3D (printed) item as defined above.

Yet further, in embodiments, the 3D printer may comprise the control system. Especially, the control system may be configured to execute the method (as described above) to provide the 3D item. Especially, the 3D printer may comprise a controller (or is functionally coupled to a controller) that is configured to execute in a controlling mode (or “operation mode”) the method as described herein. Instead of the term “controller” also the term “control system” (see e.g. above) may be applied.

In embodiments, the control system may be configured to control 3D printing conditions. Especially, the 3D printing conditions may control the first volumetric flow rate of the particulate material (to the extruder section). Further, in embodiments, the 3D printing conditions may control a second volumetric flow rate of the filament (to the nozzle shell). Furthermore, in embodiments, the 3D printing conditions may control a nozzle temperature Tₙ. Hence, in specific embodiments, the control system may be configured to control 3D printing conditions; wherein the 3D printing conditions are selected from the group of: a first volumetric flow rate of the particulate material (to the extruder section), (ii) a second volumetric flow rate of the filament (to the nozzle shell), and (iii) a nozzle temperature Tₙ.

In embodiments, the control system may be used to control the energy input to the extruder section. Further, in embodiments, the control system may control the parameter related to particle dimensions (d1) which may be selected from the group of: (a) particle dimensions (d1), and (b) energy input to the extruder section.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions form a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIG. 2a-2d schematically depict some embodiments and aspects in relation to the method for producing the 3D printed item 1, the 3D printed item 1, and the 3D printer 500;

FIG. 3 schematically depicts an application (such as a lighting device).

The schematic drawings are not necessarily to scale.

### DETAILED DESCRIPTION OF THE EMBODIMENTS

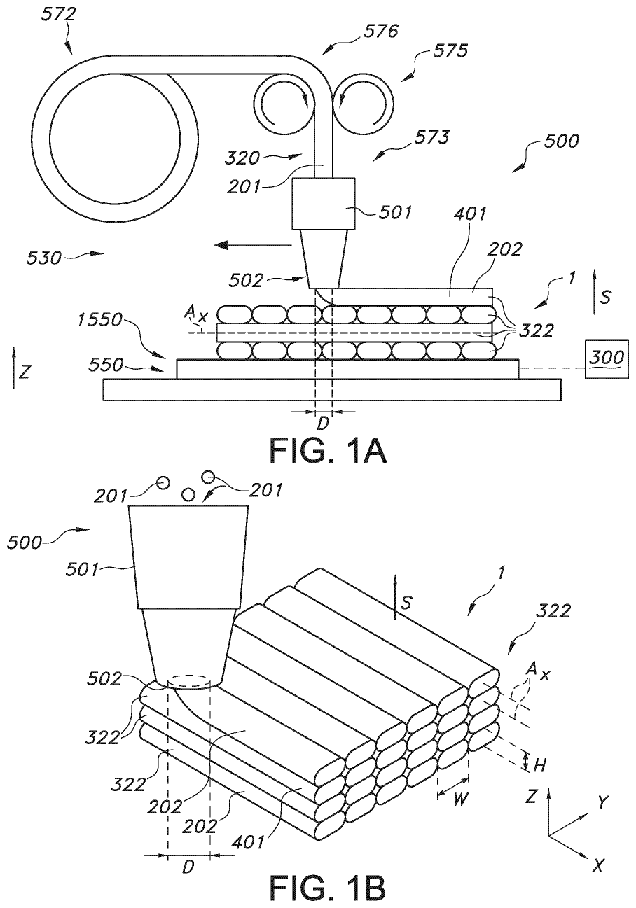

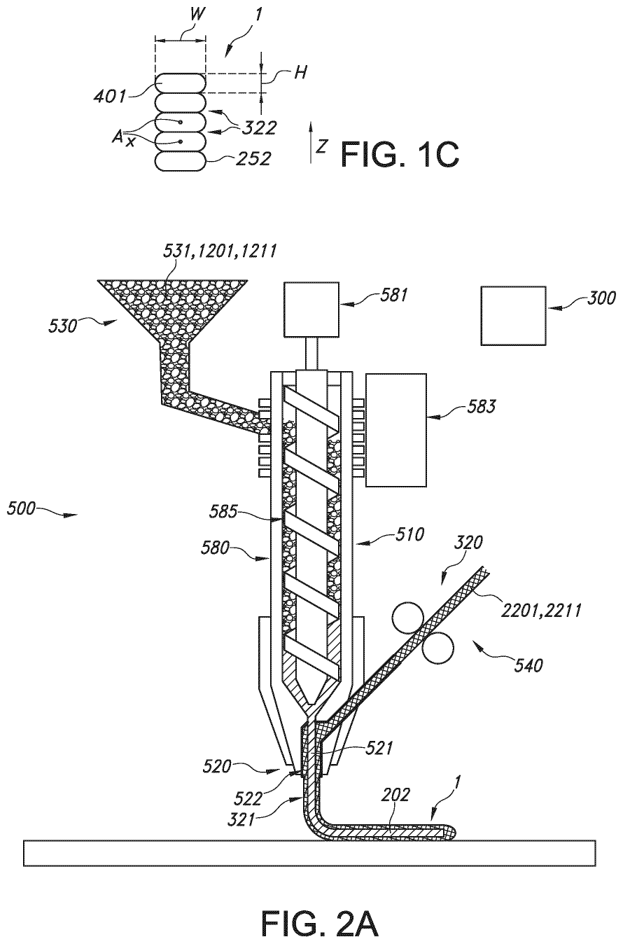

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as an FDM 3D printer head is schematically depicted. Reference 501 indicates the printer head. The 3D printer of the present invention may especially include a plurality of printer heads (see below).

Reference 502 indicates a printer nozzle. The 3D printer of the present invention may especially include a plurality of printer nozzles, though other embodiments are also possible. Reference 320 indicates a filament of printable 3D printable material (such as indicated above).

Instead of a filament also pellets may be used as 3D printable material. Both can be extruded via the printer nozzle.

For the sake of clarity, not all features of the 3D printer have been depicted, only those that are of especial relevance for the present invention (see further also below). Reference 321 indicates extrudate (of 3D printable material 201).

The 3D printer 500 is configured to generate a 3D item 1 by layer-wise depositing on a receiver item 550, which may in embodiments at least temporarily be cooled, a plurality of layers 322 wherein each layers 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic material.

The 3D printer 500 may be configured to heat the filament 320 material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in an extrudate 321 downstream of the printer nozzle which becomes a layer 322 on the receiver item or on already deposited printed material. In general, the diameter of the extrudate 321 downstream of the nozzle 502 is reduced relative to the diameter of the filament 322 upstream of the printer head 501. Hence, the printer nozzle is sometimes (also) indicated as extruder nozzle. Arranging layer 322 by layer 322 and/or layer 322 on layer 322, a 3D item 1 may be formed. Reference 575 indicates the filament providing device, which here amongst others include the spool or roller and the driver wheels, indicated with reference 576.

Reference Ax indicates a longitudinal axis or filament axis.

Reference 300 schematically depicts a control system. The control system may be configured to control the 3D printer 500. The control system 300 may be comprised or functionally coupled to the 3D printer 500. The control system 300 may further comprise or be functionally coupled to a temperature control system configured to control the temperature of the receiver item 550 and/or of the printer head 501. Such temperature control system may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material.

Reference D indicates the diameter of the nozzle (through which the 3D printable material 201 is forced).

FIG. 1b schematically depicts in 3D in more detail the printing of the 3D item 1 under construction. Here, in this schematic drawing the ends of the filaments 321 in a single plane are not interconnected, though in reality this may in embodiments be the case.

Reference H indicates the height of a layer. Layers are indicated with reference 203. Here, the layers have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIGS. 1a-1b schematically depict some aspects of a fused deposition modeling 3D printer 500, comprising (a) a first printer head 501 comprising a printer nozzle 502, (b) a filament providing device 575 configured to provide a filament 321 comprising 3D printable material 201 to the first printer head 501, and optionally (c) a receiver item 550. In FIGS. 1a-1b, the first or second printable material or the first or second printed material are indicated with the general indications printable material 201 and printed material 202, respectively. Directly downstream of the nozzle 502, the filament 321 with 3D printable material becomes, when deposited, layer 322 with 3D printed material 202.

FIG. 1c schematically depicts a stack of 3D printed layers 322, each having a layer height H and a layer width W. Note that in embodiments the layer width and/or layer height may differ for two or more layers 322. Reference 252 in FIG. 1c indicates the item surface of the 3D item (schematically depicted in FIG. 1c).

Referring to FIGS. 1a-1c, the filament of 3D printable material that is deposited leads to a layer having a height H (and width W). Depositing layer 322 after layer 322, the 3D item 1 is generated. FIG. 1c very schematically depicts a single-walled 3D item 1.

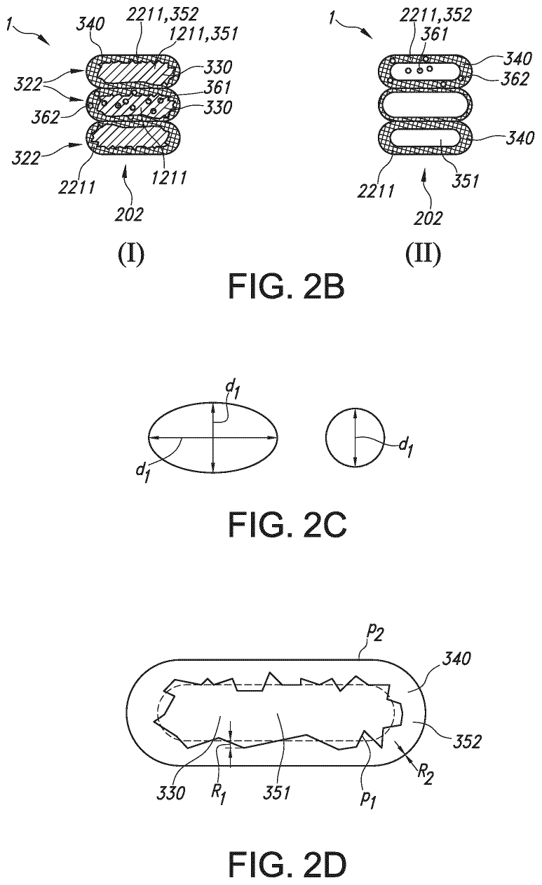

FIG. 2a-2d schematically depict some embodiments and aspects in relation to the method for producing the 3D printed item 1, the 3D printed item 1, and the 3D printer 500

FIG. 2a schematically depicts an embodiment of a fused deposition modeling 3D printer 500, comprising an extruder section 510, a nozzle section 520 configured downstream of the extruder section 510, a first feeder 530, a second feeder 540, and a control system 300. Especially, the fused deposition modeling 3D printer 500 may be configured to provide 3D printable material 201 to a substrate 1550, thereby providing a 3D item 1 comprising 3D printed material 202.

The extruder section may, in embodiments, comprise the barrel 580 and the screw 585. In embodiments, the nozzle section 520 may comprise a core-shell nozzle 502 (further) comprising (i) a nozzle core 521, configured downstream of the extruder section 510, and (ii) a nozzle shell 522 (not configured downstream of the extruder section 510).

Further, in embodiments, the first feeder 530 may be configured to feed particulate material 531 comprising a first 3D printable material 1201, to the extruder section 510, (wherein the first 3D printable material 1201 comprises a first material 1211).

Further, in embodiments, the second feeder 540 may be configured to feed a filament 320 comprising second 3D printable material 2201 to the nozzle shell 522 (wherein the second 3D printable material 2201) comprises a second material 2211, different from the first material 1211). Yet further, in embodiments, the control system 300 may be configured to execute the method.

In embodiments, the control system 300 may be configured to control 3D printing conditions. Especially, the 3D printing conditions may be selected from the group of: (i) a first volumetric flow rate of the particulate material 531 (to the extruder section 510), (ii) a second volumetric flow rate of the filament 320 (to the nozzle shell 522), and (iii) a nozzle temperature Tₙ.

Further, in embodiments, the control system 300 may be configured to monitor a parameter related to particle dimensions (d1) of the particulate material 531 and controlling 3D printing conditions in dependence of the parameter related to the particle dimensions (d1). Especially, the parameter related to particle dimensions (dl) is selected from the group of: (a) particle dimensions (d1), (b) energy input to the extruder section 510.

Amongst others, the invention may provide a method for producing a 3D item 1 by means of fused deposition modelling. Especially, the method may comprise a 3D printing stage using a fused deposition modeling 3D printer 500 for layer-wise depositing 3D printable material 201 to provide the 3D item 1 comprising a layer 322 of 3D printed material 202.

In embodiments, the 3D printer 500 may comprise an extruder section 510, a nozzle section 520 configured downstream of the extruder section 510, a first feeder 530, and a second feeder 540. Further, in embodiments, the nozzle section 520 may comprise a core-shell nozzle 502 comprising (i) a nozzle core 521, configured downstream of the extruder section 510, and (ii) a nozzle shell 522 (not configured downstream of the extruder section 510). Further, in embodiments, the first feeder 530 may be configured to feed particulate material 531 comprising a first 3D printable material 1201, to the extruder section 510, wherein the first 3D printable material 1201 may comprise a first material 1211. Yet further, the second feeder 540 may be configured to feed a filament 320 comprising second 3D printable material 2201 to the nozzle shell 522. Especially, the second 3D printable material 2201 may comprise a second material 2211, different from the first material 1211.

In embodiments, the 3D printing stage may comprise: (i) feeding the particulate material 531 to the extruder section 510 and feeding the filament 320 to the nozzle shell 522, (ii) generating a core-shell extrudate 321 via the core-shell nozzle 502 and (iii) depositing the core-shell extrudate 321 to provide the 3D printed material 202 comprising a core 330 and a shell 340, at least partly enclosing the core 330. More especially, the core 330 may comprise the first material 1211, and the shell 340 may comprise the second material 2211.

Further, in embodiments, the first material 1211 may comprise a first thermoplastic material 351 and the second material 2211 may comprise a second thermoplastic material 351. This may be due to one or more of the respective thermoplastic materials and the availability of filler materials. Especially, the first material 1211 and the second material 2211 may have different viscosities. Further, in embodiments, the first thermoplastic material 351 and the second thermoplastic material 352 may be different such as in viscosity, transition temperature, molecular weight, volume percentage, etc.

Hence, in embodiments, the first thermoplastic material 351 may have a first transition temperature T_{t,1} selected from a first glass transition temperature T_{g,1} and a first melting temperature T_{m,1}. More especially, the second thermoplastic material 352 may have a second transition temperature T_{t,2} selected from a second glass transition temperature T_{g,2} and a second melting temperature T_{m,2}. In embodiments, the method may comprise controlling a nozzle temperature Tₙ, wherein during at least part of the 3D printing stage Tₙ>T_{t,1} and Tₙ>T_{t,2} applies. Especially Tₙ≥(T_{m,1}+10° C.) and Tₙ≥(T_{m,2}+10° C.), and more especially Tₙ≥(T_{m,1}+100° C.) and Tₙ≥(T_{m,2}+100° C.).

Referring also to FIG. 2b, further, in embodiments, the first material 1211 may optionally comprise a first filler material 361. Especially, the first material 1211 may have a first melt volume rate (MVR1). In embodiments, the second material 2211 may optionally comprise a second filler material 362. More especially, the second material 1211 may have a second melt volume rate (MVR2). In embodiments, the first melt volume rate (MVR1) may be selected from the range of 0.1-1 cm³/(10 min.). Further, in embodiments, the second melt volume rate (MVR2) may be selected from the range of 1-30 cm³/(10 min.). Especially, 1<MVR1/MVR2≤0.003 (according to ISO 1133 12 at 300° C. and 1.2 kg).

In embodiments, the first thermoplastic material 351 may have a first average molecular weight M_{n,1}, and the second thermoplastic material 352 may have a second average molecular weight M_{n,2}. The definition of molecular weight is provided above and is measured in g/mol. In embodiments, the first average molecular weight M_{n,1} may be selected from the range of 60000-500000 g/mol, and wherein the second average molecular weight M_{n,2}, may be selected from the range of 10000-100000 g/mol. More especially, 1<M_{n,1}/M_{n,2}≤50.

Alternatively, in embodiments, the first thermoplastic material 351 may have a first average molecular weight M_{n,1}, and the second thermoplastic material 352 may have a second average molecular weight M_{n,2}. Especially, the first average molecular weight M_{n,1} may be selected from the range of 10000-100000 g/mol, and the second average molecular weight M_{n,2}, may be selected from the range of 60000-500000 g/mol. Especially, 1<M_{n,1}/M_{n,2}≤50.

As indicated above, in embodiments, the first material 1211 may have a first viscosity PV1, and the second material 2211 may have a second viscosity PV2, different from the first viscosity PV1. Especially, 1<PV1/PV2≤500. Alternatively, in embodiments, 1<PV2/PV1≤500.

Further amongst others, the 3D printer 500 may use the 3D printing method (described above) to provide a 3D item 1. In embodiments, the 3D item 1 may be provided by layer-wise deposition of 3D printable material 1201. Hence, in this way, in embodiments, the 3D item may be provided comprising layers of 3D printed material 202.

As mentioned before, the 3D item 1 may comprise 3D printed material 202 comprising the first thermoplastic material 351 and the second thermoplastic material 352. Especially, the first thermoplastic material 351 may have a first transition temperature T_{t,1} selected from a first glass transition temperature T_{g,1} and a first melting temperature T_{m,1}.

Further, in embodiments, the first material 1211 may optionally comprise a first filler material 361. Likewise, in embodiments, the second material 2211 may optionally comprise a second filler material 362.

Hence, in embodiments the particulate material 531 fed to the extruder may comprise first thermoplastic material and first filler material, embedded in the first thermoplastic material, wherein the first filler material may comprise particulate filler material. Therefore, the pellets 531 may comprise smaller filler particles.

FIG. 2b schematically depicts two embodiments of the layers comprised by the 3D item 1 further comprising 3D printed material 202. In this embodiment, the plurality of the layers 322 may not especially be the same. In embodiments, the first material 1211 may comprise the first thermoplastic material 351 and the second material 2211 may comprise the second thermoplastic material 352. Especially, the first material 1211 (i.e. the core 330 of the middle layer 322 in this embodiment) may comprise the (particulate) first filler material 361, whereas the other layers may not comprise such first filler material 361. Further, in embodiments, the second material 2211 (i.e. the shell 340 of the middle layer 322 in this embodiment) may comprise the second filler material 362. Note that embodiment I depicts a (highly) filled first material i.e. the core 330 may comprise a high volume percentage concentration (such as 50 vol. %) of first filler material 361.

Embodiment II depicts an embodiment of the layers comprised by the 3D item 1 further comprising 3D printed material 202. Embodiment II may be similar to embodiment I, and for the sake of brevity these details are not repeated. However, the features of embodiment do not in any way limit the scope of the features of embodiment II. Especially, embodiment II depicts the 3D item 1 comprising the first material 1211 and the second material 2211 further comprising first material 351 and second material 352. The top layer 322 in this embodiment may comprise the first material 1211 comprising first filler material 361 (i.e. within the core 330) and second material 2211 comprising second filler material 362 (i.e. within the shell 340). Note that embodiment II depicts a (highly) filled first material i.e. the core 330 may comprise a low volume percentage concentration (such as 15 vol. %) of first filler material 361.

Note that, in embodiments, the first material 1211 and the second material 2211 may differ in one or more of molecular weight of the thermoplastic material, viscosity, chemical composition, filler material, filler material concentration. Hence, in embodiments, the first thermoplastic material 351 may have a first average molecular weight M_{n,1}, and the second thermoplastic material 352 may have a second average molecular weight M_{n,2}.

Especially, the first average molecular weight M_{n,1} may be selected from the range of 60000-500000 g/mol, and the second average molecular weight M_{n,2}, may be selected from the range of 10000-100000 g/mol. More especially 1<M_{n,1}/M_{n,2}≤50. Alternatively, in embodiments, the first average molecular weight M_{n,1} may be selected from the range of 10000-100000 g/mol, and the second average molecular weight M_{n,2}, may be selected from the range of 60000-500000 g/mol. More especially, in such an embodiment, 1<M_{n,1}/M_{n,2}≤50 may apply. Yet further, the first thermoplastic material 351, and the second thermoplastic material 352 may be selected such that M_{n,1}≠M_{n,2}≤50. Especially, at least one of the (particulate) first filler material 361 and the (particulate) second filler material 362 may be selected from the group of glass or fibers.

In embodiments, the first material 1211 may comprise a first filler material 361 at a first volume percentage V1 relative to the first material 1211, and the second material 2211 may optionally comprise a second filler material 362 at a second volume percentage V2 relative to the second material 2211. Especially, the first volume percentage V1 may be selected from the range of 5-50 vol. %, and the second volume percentage V2 may be selected from the range of 0-15 vol. %, and wherein 0≤V2/V1≤0.5.

Further, in embodiments, the first material 1211 may comprise a first filler material 361 at a first volume percentage V1 relative to the first material 1211, and the second material 2211 may comprise a second filler material 362 at a second volume percentage V2 relative to the second material 2211. Especially, the first filler material 361 and the second filler material 362 may be different filler materials. Yet further, in embodiments, the first material 1211 may comprise a first filler material 361 at a first volume percentage V1 (relative to the first material 1211), and the second material 2211 may comprise a second filler material 362 at a second volume percentage V2 (relative to the second material 2211). Especially, the first filler material 361 and the second filler material 362 may be different filler materials.

FIG. 2c schematically depicts an embodiment of particulate material 531. Especially, the core may be based on particulate materials which is fed to the extruder section. More especially, the particulate material may comprise particle dimensions d1, which may be a diameter, a length, etc. In embodiments, d1 may be the diameter of the particulate material for a spherical particulate material. However, alternatively or additionally, the parameter d1 may be the major or minor axis of an elliptical particulate material 531. In other embodiments, d1 may (also) be length, width, height, etc.

Further, in embodiments, the method may comprise monitoring a parameter related to particle dimensions d1 of the particulate material 531 and controlling 3D printing conditions in dependence of the parameter related to the particle dimensions d1. Especially, the parameter related to particle dimensions d1 may be selected from the group of: (a) particle dimensions d1, and (b) energy input to the extruder section 510.

FIG. 2d schematically depicts 3D printable material 201 (and/or 3D printed material 202) comprising a core 330 further comprising first thermoplastic material 351. Furthermore, in embodiments, the 3D printable material 201 (and/or 3D printed material 202) may comprise a shell 340 further comprising second thermoplastic material 352. Especially, the surface of the core 330 and/or the shell 340 may not be smooth. Hence, in embodiments, the core 330 may have first deviations R1 on its surface and the shell 340 may have second deviations R2 on its surface. As a result, in embodiments, the core 330 and the shell 340 may have a perimeter p1 and p2, respectively.

In embodiments of the 3D item, the 3D item 1 may comprise a layer 322 of 3D printed material 202. Especially, the layer 322 may comprise a core-shell cross-section, comprising a core 330 and a shell 340, at least partly enclosing the core 330. More especially, the core 330 may comprise a first material 1211, and the shell 340 may comprise a second material 2211, different from the first material 1211. In embodiments, the core 330 may have a first perimeter p1 with first deviations R1 therefrom defining a first root mean square roughness RMS1, and the shell 340 may have a second perimeter p2 with second deviations R2 therefrom defining a second root mean square roughness RMS2. Especially, RMS1/RMS2≤0.5.

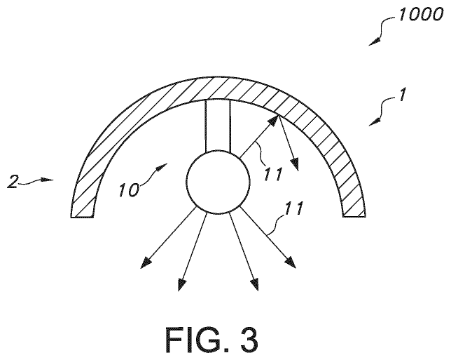

FIG. 3 schematically depicts an embodiment of a lamp or luminaire, indicated with reference 2, which comprises a light source 10 for generating light 11. The lamp may comprise a housing or shade or another element, which may comprise or be the 3D printed item 1. Here, the half sphere (in cross-sectional view) schematically indicates a housing or shade. The lamp or luminaire may be or may comprise a lighting device 1000 (which comprises the light source 10). Hence, in specific embodiments the lighting device 1000 comprises the 3D item 1. The 3D item 1 may be configured as one or more of (i) at least part of a lighting device housing, (ii) at least part of a wall of a lighting chamber, and (iii) an optical element. Hence, the 3D item may in embodiments be reflective for light source light 11 and/or transmissive for light source light 11. Here, the 3D item may e.g. be a housing or shade. The housing or shade comprises the item part 400. For possible embodiments of the item part 400, see also above.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A method for producing a 3D item (1) by means of fused deposition modelling, the method comprising a 3D printing stage using a fused deposition modeling 3D printer for layer-wise depositing 3D printable material to provide the 3D item (1) comprising a layer of 3D printed material; wherein:
the 3D printer comprises an extruder section, a nozzle section configured downstream of the extruder section, a first feeder, and a second feeder; wherein:
the nozzle section comprises a core-shell nozzle comprising (i) a nozzle core, configured downstream of the extruder section, and (ii) a nozzle shell;
the first feeder is configured to feed particulate material comprising a first 3D printable material, to the extruder section, wherein the first 3D printable material comprises a first material;
the second feeder is configured to feed a filament comprising second 3D printable material to the nozzle shell, wherein the second 3D printable material comprises a second material, different from the first material;
the 3D printing stage comprises:
feeding the particulate material to the extruder section and feeding the filament to the nozzle shell;
generating a core-shell extrudate via the core-shell nozzle and;
depositing the core-shell extrudate to provide the 3D printed material comprising a core and a shell, at least partly enclosing the core, wherein the core comprises the first material, and wherein the shell comprises the second material.

2. The method according to claim 1, wherein the first material comprises a first thermoplastic material and wherein the second material comprises a second thermoplastic material different from the first thermoplastic material; wherein the first material and wherein the second material differ in one or more of molecular weight of the thermoplastic material, viscosity, chemical composition, filler material, filler material concentration.

3. The method according to claim 2, wherein the first thermoplastic material has a first average molecular weight M_{n,1}, and wherein the second thermoplastic material has a second average molecular weight M_{n,2}, wherein the first average molecular weight M_{n,1} is selected from the range of 60000-500000 g/mol, and wherein the second average molecular weight M_{n,2}, is selected from the range of 10000-100000 g/mol; wherein 1<M_{n,1}/M_{n,2}≤50.

4. The method according to claim 2, wherein the first thermoplastic material has a first transition temperature T_{t,1} selected from a first glass transition temperature T_{g,1} and a first melting temperature T_{m,1}, wherein the second thermoplastic material has a second transition temperature T_{t,2} selected from a second glass transition temperature T_{g,2} and a second melting temperature T_{m,2}, wherein the method comprises controlling a nozzle temperature Tₙ, wherein during at least part of the 3D printing stage Tₙ>T_{t,1} and Tₙ>T_{t,2} applies.

5. The method according to claim 1, wherein the first material comprises a first filler material at a first volume percentage V1 relative to the first material, and wherein the second material optionally comprises a second filler material at a second volume percentage V2 relative to the second material, wherein the first volume percentage V1 is selected from the range of 5-50 vol. %, wherein the second volume percentage V2 is selected from the range of 0-15 vol. %, and wherein 0≤V2/V1≤0.5.

6. The method according to claim 1, wherein the first material comprises a first filler material at a first volume percentage V1 relative to the first material, and wherein the second material comprises a second filler material at a second volume percentage V2 relative to the second material, wherein the first filler material and the second filler material are different filler materials.

7. The method according to claim 1, further comprising a control system, wherein the control system is configured to control 3D printing conditions; wherein the 3D printing conditions are selected from the group of: (i) a first volumetric flow rate of the particulate material, (ii) a second volumetric flow rate of the filament, and (iii) a nozzle temperature Tₙ as defined in claim 4.

8. A 3D item (1) comprising 3D printed material, wherein the 3D item (1) comprises a layer of 3D printed material, wherein the layer comprises a core-shell cross-section, comprising a core and a shell, at least partly enclosing the core wherein the core comprises a first material, and wherein the shell comprises a second material, different from the first material, wherein the core has a first perimeter (p1) with first deviations (R1) therefrom defining a first root mean square roughness RMS1, wherein the shell has a second perimeter (p2) with second deviations (R2) therefrom defining a second root mean square roughness RMS2, wherein RMS1/RMS2≤0.5.

9. The 3D item (1) according to claim 8, wherein the first material comprises a first thermoplastic material and wherein the second material comprises a second thermoplastic material different from the first thermoplastic material wherein the first thermoplastic material and wherein the second thermoplastic material differ in one or more of molecular weight of the thermoplastic material, viscosity, chemical composition, filler material, filler material concentration.

10. The 3D item (1) according to claim 9, wherein the first thermoplastic material has a first transition temperature T_{t,1} selected from a first glass transition temperature T_{g,1} and a first melting temperature T_{m,1}, wherein the second thermoplastic material has a second transition temperature T_{t,2} selected from a second glass transition temperature T_{g,2} and a second melting temperature T_{m,2}.

11. The 3D item (1) according to claim 8, wherein the first material comprises a first filler material at a first volume percentage V1 relative to the first material, and wherein the second material optionally comprises a second filler material at a second volume percentage V2 relative to the second material, wherein the first volume percentage V1 is selected from the range of 5-50 vol. %, wherein the second volume percentage V2 is selected from the range of 0-15 vol. %, and wherein 0≤V2/V1≤0.5.

12. The 3D item (1) according to claim 9, wherein the first thermoplastic material has a first average molecular weight M_{n,1}, and wherein the second thermoplastic material has a second average molecular weight M_{n,2}, M_{n,1}≠M_{n,2}≤50, wherein at least one of the first material and the second filler material (362) are selected from the group of glass and fibers.

13. A lighting device comprising the 3D item (1) according to claim 8, wherein the 3D item (1) is configured as one or more of (i) at least part of a lighting device housing, (ii) at least part of a wall of a lighting chamber, and (iii) an optical element.

14. A fused deposition modeling 3D printer, comprising an extruder section, a nozzle section configured downstream of the extruder section, a first feeder, a second feeder, and a control system; wherein the fused deposition modeling 3D printer is configured to provide 3D printable material to a substrate, thereby providing a 3D item (1) comprising 3D printed material, wherein:
the nozzle section comprises a core-shell nozzle comprising (i) a nozzle core, configured downstream of the extruder section, and (ii) a nozzle shell;
the first feeder is configured to feed particulate material comprising a first 3D printable material, to the extruder section;
the second feeder is configured to feed a filament comprising second 3D printable material to the nozzle shell, and
the control system, wherein the control system is configured to execute the method according to claim 1.

15. The fused deposition modeling 3D printer according to claim 14, wherein the control system is configured to control 3D printing conditions; wherein the 3D printing conditions are selected from the group of: (i) a first volumetric flow rate of the particulate material (ii) a second volumetric flow rate of the filament, and (iii) a nozzle temperature Tₙ.
